(19) United States
(12) Patent Application Publication
(10) Pub. No.: US 2008/0205746 A1
(43) Pub. Date: Aug. 28, 2008

(54) METHOD OF INSPECTING AN IDENTIFICATION MARK, METHOD OF INSPECTING A WAFER USING THE SAME, AND APPARATUS FOR PERFORMING THE METHOD

(75) Inventors: Jae-Kyun KO, Gyeonggi-do (KR); Young-Kyu LIM, Gyeonggi-do (KR); Je-Kwon PARK, Gyeonggi-do (KR); Hyun-Hee KIM, Gyeonggi-do (KR); Kyu LEE, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/037,794

(22) Filed: Feb. 26, 2008

(30) Foreign Application Priority Data
Feb. 27, 2007 (KR) 2007-0019793

(51) Int. Cl. G06K 9/00

(52) U.S. Cl. 382/145

(57) ABSTRACT

In a method of inspecting an identification mark, an image of the identification mark on a semiconductor wafer is obtained. The identification mark may be identified using the identification mark image. A region where the identification mark is formed may be inspected using the identification mark image after the identification mark is identified.

### CROSS-REFERENCE TO RELATED APPLICATIONS

This application claims priority under 35 U.S.C. §119 to Korean Patent Application No. 2007-19793, filed on Feb. 27, 2007 in the Korean Intellectual Property Office (KIPO), the contents of which are herein incorporated by reference in their entirety.

### BACKGROUND OF THE INVENTION

1. Field of the Invention

Embodiments of the present invention relate to a method of inspecting an identification mask, a method of inspecting a semiconductor wafer using the same, and an apparatus for performing the method. More particularly, embodiments of the present invention relate to a method of inspecting an identification mark on the wafer to identify the identification mark and detect defects of the identification mark, a method of inspecting the wafer using the same, and an apparatus for performing the method.

2. Description of the Related Art

Generally, a wafer for manufacturing a semiconductor device may have a peculiar identification mark. The identification mark may be formed by etching or carving the wafer using a laser beam. The identification mark may be used for individually managing the wafer. Thus, it may be required to investigate whether the identification mark is normal or not, so as to manage the wafer.

Conventional methods of inspecting an identification mark may use a manual inspection using a scope, a wafer inspection apparatus, etc. The manual inspection method may not be suitable for inspecting a plurality of wafers because an inspector has to manually inspect each wafer. Further, since determination references may be different from one another in accordance with the inspectors, the manual inspection method may have very low inspection accuracy. The wafer inspection apparatus may determine an inspection region as a defect only when the identification mark is not identified. However, when a defect exists in a region where the identification mark is positioned, although the identification mark is normal, the wafer inspection apparatus may identify the identification mark to be normal. Here, since the defect may be recognized in an electrical die sorting (EDS) process for testing electrical characteristics of semiconductor devices, it may be difficult to perform a rework process for removing the defect. Further, inspection results obtained from the wafer inspection apparatus may have very low reliability.

### SUMMARY OF THE INVENTION

Some embodiments of the present invention provide a method of inspecting an identification mark that is capable of rapidly detecting defects of the identification mark.

Some embodiments of the present invention also provide a method of inspection of a wafer using the above-mentioned method.

Some embodiments of the present invention also provide an apparatus for performing the above-mentioned method.

In a method of inspecting an identification mark in accordance with one aspect of the present invention, an image of the identification mark on a wafer is obtained. The identification mark is then identified using the identification mark image. A region where the identification mark is formed is inspected using the identification mark image.

According to one example embodiment, identifying the identification mark may be determined whether the identification mark image is matched with any predetermined reference identification mark images by comparing the identification mark image with the reference identification mark images.

According to another example embodiment, inspecting the region where the identification mark is formed may include obtaining a gray level difference between the identification mark image and the reference identification mark images by comparing the identification mark image with the reference identification mark image, and determining a defect of the identification mark by comparing the gray level difference with a reference value. Further, obtaining the gray level difference may include calculating an average of gray levels on pixels in comparison regions where the identification mark image and the reference identification mark image are placed, respectively, and calculating the difference between the calculated gray level averages. Here, the reference value may be about 50 to about 60.

In a method of inspecting a wafer in accordance with another aspect of the present invention, the wafer is aligned using an image of the wafer having a circuit pattern and an identification mark. Identifying the identification mark and inspecting a region where the identification mark is formed are carried out using an identification mark image. A defect of the circuit pattern is then inspected using an image of the circuit pattern.

According to one example embodiment, inspecting the region may include obtaining the identification mark image, identifying the identification mark using the identification mark image, and inspecting the region using the identification mark image.

According to another example embodiment, the wafer image and the identification mark image may have substantially the same magnification.

According to still another example embodiment, inspecting the defect of the circuit pattern may include obtaining the circuit pattern image, comparing the circuit pattern image with a predetermined reference circuit pattern image to calculate a gray level difference between the circuit pattern image and the reference circuit pattern image, and comparing the gray level difference with a reference value.

An apparatus for inspecting a wafer in accordance with still another aspect of the present invention includes a wafer-aligning unit, an image-obtaining unit, a first image-processing unit, a second image-processing unit and a third image-processing unit. The wafer-aligning unit aligns the wafer. The image-obtaining unit obtains images of an identification mark and a circuit pattern on the wafer. The first image-processing unit identifies the identification mark using the identification mark image. The second image-processing unit inspects a defect of a region where the identification mark is formed using the identification mark image. The third image-processing unit inspects a defect of the circuit pattern using the circuit pattern image.

According to one example embodiment, the first image-processing unit may determine whether the identification mark image is matched with any one of predetermined reference identification mark images by comparing the identification mark image with the reference identification mark images.

According to another example embodiment, the second image-processing unit, a first comparator for calculating a gray level difference between the identification mark image and the reference identification mark images by comparing the identification mark image with the reference identification mark images, and a first determiner for determining the defect of the identification mark by comparing the gray level difference with a reference value.

According to still another example embodiment, the third image-processing unit a second comparator for calculating a gray level difference between the circuit pattern image and predetermined reference circuit pattern images by comparing the circuit pattern image with the reference circuit pattern mark image, and a second determiner for determining the defect of the circuit pattern by comparing the gray level difference with a reference value.

According to the present invention, the region where the identification mark is formed may be inspected using the identification mark image as well as the identification of the identification mark. Thus, problems caused by the defect in the region where the identification mark is formed may not be generated. Further, the region where the identification mark is formed may be inspected by the process of the present invention substantially the same as that for inspecting the circuit pattern on the wafer so that the time for inspecting the identification mark and the circuit pattern may be remarkably reduced.

### BRIEF DESCRIPTION OF THE DRAWINGS

The above and other features and advantages of the present invention will become readily apparent by reference to the following detailed description when considered in conjunction with the accompanying drawings, wherein:

FIG. 1 is a block diagram illustrating an apparatus for inspecting a wafer in accordance with an example embodiment of the present invention;

FIG. 2 is a flow chart illustrating a method of inspecting an identification mark; and

FIG. 3 is a flow chart illustrating a method of inspecting a wafer using the method in FIG. 2.

### DETAILED DESCRIPTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Apparatus for Inspecting a Wafer

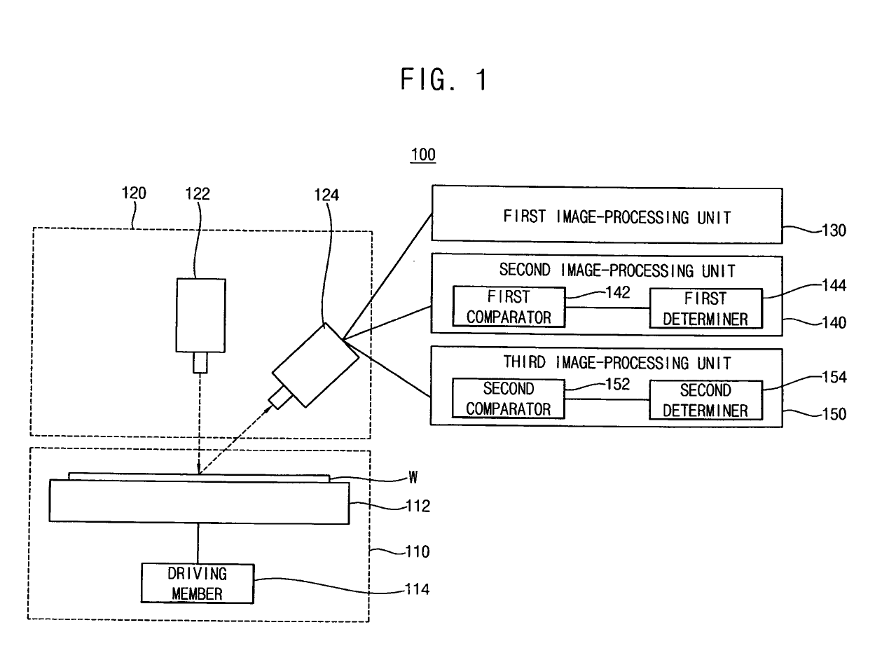

FIG. 1 is a block diagram illustrating an apparatus for inspecting a wafer in accordance with an example embodiment of the present invention.

Referring to FIG. 1, an apparatus 100 for inspecting a wafer of this example embodiment includes a wafer-aligning unit 110, an image-obtaining unit 120, a first image-processing unit 130, a second image-processing unit 140 and a third image-processing unit 150.

The wafer-aligning unit 110 aligns a wafer W. An identification mark and a circuit pattern may be formed on the wafer W. The wafer-aligning unit 110 includes a supporting member 112 and a driving member 114.

The supporting member 112 supports the wafer W. The driving member 114 is coupled to the supporting member 112. The driving member 114 moves the supporting member 112 along an x-direction and a y-direction and rotates the supporting member 112. Further, the driving member 114 may tilt the supporting member 112. Thus, the wafer W is aligned on the supporting member 112 using the driving member 114.

The image-obtaining unit 120 obtains images of the identification mark and the circuit pattern. The image-obtaining unit 120 may include a light source 122 and a light-detecting member 124. The light source 122 may be positioned over the supporting member 112. The light source 122 irradiates a light onto the wafer W on the supporting member 112. Particularly, the light source 122 irradiates the light onto the identification mark and the circuit pattern on the wafer W. Examples of the light source 122 may include a light emitting diode (LED), a laser generator, etc.

The light-detecting member 124 is arranged substantially over the supporting member 112. Here, the light irradiated to the wafer W may be reflected or scattered from regions where the identification mark and the circuit pattern are formed, respectively. The light-detecting member 124 detects the reflected light or the scattered light from the wafer W. The light-detecting member 124 amplifies the detected light and then coverts the amplified light into an electrical signal. The light-detecting member 124 may convert the electrical signal into images having digital signals. The light-detecting member 124 may also obtain an image of a specific region on the wafer W. Thus, the light-detecting member 124 may be used for aligning the wafer W. As a result, the light-detecting member 124 obtains the identification mark image and the circuit pattern image.

In this example embodiment, the light-detecting member 124 for obtaining the image of the specific region on the wafer W may have a magnification substantially the same as that of the light-detecting member 124 for obtaining the identification mark image. Thus, since it is not necessary to change the magnification of the light-detecting member 124, the image of the specific region on the wafer W and the identification mark image may be rapidly obtained. Alternatively, the magnification of the light-detecting member 124 for obtaining the image of the specific region on the wafer W may be different from that of the light-detecting member 124 for obtaining the identification mark image.

The first image-processing unit 130 may determine whether the identification mark is identified or not using the identification mark image. Particularly, the first image-processing unit 130 compares the identification mark image obtained from the image-obtaining unit 120 with predetermined reference identification mark images. That is, a shape of the identification mark image is compared with shapes of the reference identification mark images. The first image-processing unit 130 determines whether the identification mark image matches any one of the reference identification mark images. Here, when the identification mark image is not matched with any of the reference identification mark images, the first image-processing unit 130 associates the identification mark with an identification failure. In contrast, when the identification mark image is matched with any one of the reference identification mark images, the first image-processing unit 130 associates the identification mark with an identification success. Thus, the first image-processing unit 130 identifies the identification mark using the above-mentioned techniques.

The second image-processing unit 140 may determine a defect of a region where the identification mark is formed using the identification mark image. The second image-processing unit 140 may include a first comparator 142 and a first determiner 144.

The first comparator 142 compares the identification mark image obtained from the image-obtaining unit 120 with the reference identification mark images. Specifically, the first comparator 142 may compare a gray level of the identification mark image with a gray level of at least one of the reference identification mark images. More particularly, averages are obtained of the gray levels on pixels in comparison regions where the identification mark image and the reference identification mark image are placed, respectively. The gray level averages on the pixels in the comparison regions are compared with each other. The comparison regions may have various sizes. For example, the size of the comparison regions may be (1×1) pixel, (2×2) pixels, (3×3) pixels, etc. Differences of the gray level averages between the comparison regions may be calculated.

The first determiner 144 determines whether the identification mark image is matched with the reference identification mark image or not. When any one of the gray level differences of each of the comparison regions is above a reference value, the first determiner 144 determines the region to be abnormal. In contrast, when the gray level differences of each of the comparison regions are no more than the reference value, the first determiner 144 determines the region to be normal. For example, the reference value may be about 50 to 60. Thus, the first determiner 144 determines the defect of the region where the identification mark is formed using the above-mentioned techniques.

When the size of the comparison regions correspond to the unit pixel, i.e., the (1×1) pixel size, the identification mark image may be determined to be abnormal due to noise in any pixel. However, when the size of the comparison regions is larger than that of the unit pixel, the identification mark may not be determined to be abnormal, although noise is generated in the pixel, because the gray level averages of the pixels in the comparison regions are calculated.

The third image-processing unit 150 determines a defect of a region where the circuit pattern is formed using the circuit pattern image. The third image-processing unit 150 may include a second comparator 152 and a second determiner 154.

The second comparator 152 compares the circuit pattern image obtained from the image-obtaining unit 120 with reference circuit pattern images. Specifically, the second comparator 152 may compare a gray level of the circuit pattern image with a gray level of at least one of the reference circuit pattern images. More particularly, averages are obtained of the gray levels on pixels in comparison regions where the circuit pattern image and the reference circuit pattern image are placed, respectively. The gray level averages on the pixels in the comparison regions are compared with each other. Differences of the gray level averages between the comparison regions may be calculated.

The second determiner 154 determines whether the circuit pattern is matched with the reference circuit pattern image or not. When any one of the gray level differences of each of the comparison regions is above a reference value, the second determiner 154 determines the region to be abnormal. In contrast, when the gray level differences of each of the comparison regions are no more than the reference value, the second determiner 154 determines the region to be normal. Thus, the second determiner 154 determines the region where the circuit pattern is formed using the above-mentioned techniques.

According to this example embodiment, the apparatus 100 may inspect the defects in the identification mark and the circuit pattern on the wafer W. Particularly, the apparatus 100 may inspect defects of characters in the identification mark and defects of the region where the identification mark is formed.

Method of Inspecting an Identification Mark

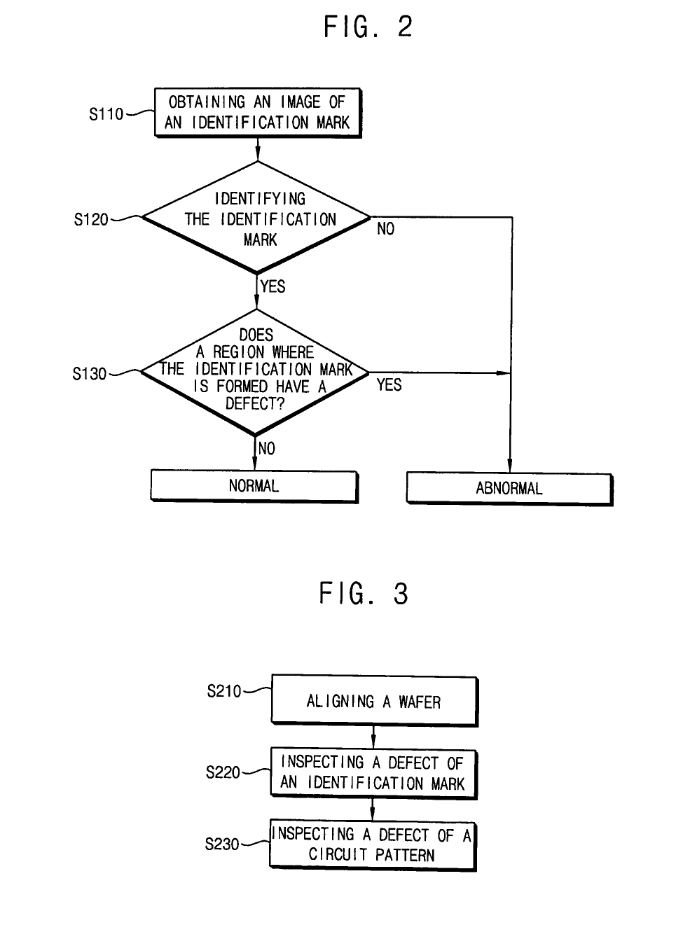

FIG. 2 is a flow chart illustrating a method of inspecting an identification mark.

Referring to FIG. 2, in step S110, an image of an identification mark on a wafer is obtained. In this example embodiment, a light is irradiated to the wafer to scan a region where the identification mark is formed. The light is reflected or scattered from regions where the identification mark is detected. The detected light is amplified to convert the amplified light into an electrical signal. The electrical signal may be converted into an image having a digital signal. Therefore, the identification mark image is obtained.

In step S120, the identification mark is identified using the identification mark image. In this example embodiment, the identification mark image is compared with predetermined images of reference identification marks. That is, a shape of the identification mark image is compared with shapes of the reference identification mark images. Here, the reference identification marks may be normally formed characters on the wafer. The identification mark may include alphabets, numbers, etc.

When the identification mark image is not matched with any one of the reference identification mark images, the identification of the identification mark is determined as an identification failure. In this case, the process for inspecting the identification mark is suspended. In contrast, when the identification mark image is matched with any one of the reference identification mark images, the identification of the identification mark is determined to be an identification success.

In step S130, after the identification mark is identified, the region where the identification mark is formed is inspected using the identification mark image to determine a defect of the region according to one embodiment of the present invention.

In this example embodiment, averages are calculated of the gray levels on pixels in the comparison regions where the identification mark image and the reference identification mark image are placed, respectively. The gray level averages on the comparison regions are compared with each other. Here, the comparison regions may have various sizes. For example, the size of the comparison regions may be (1×1) pixel, (2×2) pixels, (3×3) pixels, etc. Differences of the gray level averages between the comparison regions may be calculated.

When any one of the average gray level differences is above a reference value, the region is determined to be abnormal. In contrast, when the average gray level differences are no more than the reference value, the region is determined to be normal. Therefore, whether the defect exists or not in the region may be rapidly recognized. As a result, when the defect exists in the region where the identification mark is formed, the defect may be immediately removed or a rework process may be readily performed on a layer including the defect.

Here, the reference value may vary in accordance with accuracy of the process for inspecting the region where the identification mark is formed. For example, the reference value may become lower proportional to the increase of the accuracy of the process for inspecting the region where the identification mark is formed. That is, when the accuracy is high, the gray level difference may be set as a low value so as to determine the region where the identification mark is formed to be normal. In contrast, the reference value may become higher proportional to the decrease of the accuracy of the process for inspecting the region where the identification mark is formed. Preferably, the reference value may be anywhere between about 50 to about 60.

When the size of the comparison regions correspond to the unit pixel, i.e., the (1×1) pixel size, the identification mark image may be determined to be abnormal due to noise in any pixel. However, when the size of the comparison regions is larger than that of the unit pixel, the identification mark may not be determined to be abnormal, although noise is generated in the pixel, because the gray level averages of the pixels in the comparison regions are calculated.

According to this example embodiment, the identification mark may be identified by inspecting the region where the identification mark is formed. Thus, the inspection method according to various example embodiments described above improves inspection reliability.

Method of Inspecting a Wafer

FIG. 3 is a flow chart illustrating a method of inspecting a wafer using the method in FIG. 2. Referring to FIG. 3, in step S210, a wafer on which an identification mark and a circuit pattern are formed is aligned.

In this example embodiment, the wafer is loaded into an inspection chamber. A light is irradiated to the wafer W to scan the wafer. The light reflected or scattered from the wafer is detected. The detected light is amplified to convert the amplified light into an electrical signal. The electrical signal may be converted into images having digital signals, thereby obtaining an image of the wafer. The wafer may be moved while recognizing the image of the wafer to align the wafer at an alignment position.

In step S220, a defect of the identification mark is inspected. In this example embodiment, an image of the identification mark is obtained. Identification of the identification mark is determined using the identification mark image. When the identification mark is identified, a defect in the region where the identification mark is formed is identified. Here, the process for inspecting the defect of the identification mark is substantially the same as that illustrated with reference to FIG. 2. Thus, any further illustrations with respect to the process for inspecting the defect of the identification mark are omitted herein for brevity.

In this example embodiment, the wafer image and the identification mark image may be obtained using an apparatus having substantially the same magnification. Thus, since it is not necessary to change the magnification, the wafer image and the identification mark image may be rapidly obtained.

In step S230, a defect of the circuit pattern is inspected. To inspect the circuit pattern, an image of the circuit pattern is obtained.

In this example embodiment, light is irradiated to the wafer W to scan the circuit pattern on the wafer. The light reflected or scattered from the circuit pattern is detected. The detected light is amplified to convert the amplified light into an electrical signal. The electrical signal may be converted into images having digital signals, thereby obtaining an image of the circuit pattern.

The circuit pattern image is compared with a predetermined reference circuit pattern image to determine whether the circuit pattern is normal or not. In this example embodiment, an image of a region where the circuit pattern is formed is compared to the reference circuit pattern image. A gray level difference between the circuit pattern image and the reference circuit pattern image is calculated. Averages of the gray levels on pixels in comparison regions of the circuit pattern image and the reference circuit pattern image are calculated. The calculated average gray levels of the comparison regions are compared with each other. Here, the comparison regions may have various sizes. Differences of the average gray levels of the circuit pattern image and the reference circuit pattern image are calculated between the comparison regions.

When the differences between the average gray levels are within a predetermined allowable range, the circuit pattern is determined to be normal. In contrast, when the differences between the average gray levels are beyond the predetermined allowable range, the circuit pattern is determined to be abnormal.

According to the present invention, the region where the identification mark is formed may be inspected using the identification mark image as well as the identification of the identification mark. Thus, problems caused by the defect in the region where the identification mark is formed may be avoided. Further, the region where the identification mark is formed may be inspected by the process of the present invention substantially the same as that for inspecting the circuit pattern on the wafer so that a time for inspecting the identification mark and the circuit pattern may be remarkably reduced.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of this invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of inspecting an identification mark, comprising:
obtaining an image of the identification mark on a semiconductor wafer;
identifying the identification mark using the identification mark image; and
inspecting a region where the identification mark is formed using the identification mark image.

2. The method of claim 1, wherein identifying the identification mark comprises determining whether the identification mark image matches any images of predetermined reference identification marks by comparing the identification mark image with at least one of the reference identification mark images.

3. The method of claim 1, wherein inspecting the region where the identification mark is formed comprises:
comparing the identification mark image with at least one predetermined reference identification mark image by calculating gray level differences between a region of the identification mark image and a region of the at least one predetermined reference identification mark image; and
when any of the gray level differences are higher than a reference value, determining whether the identification mark has a defect.

4. The method of claim 3, wherein calculating the gray level differences comprises:
calculating averages of gray levels on pixels in comparison regions of the identification mark image and the at least one reference identification mark image; and
calculating a difference between the calculated gray level averages.

5. The method of claim 3, wherein the reference value is about 50 to about 60.

6. A method of inspecting a semiconductor wafer, comprising:
aligning the semiconductor wafer, which has a circuit pattern and an identification mark, using a wafer image that includes a circuit pattern image and an identification mark image;
performing identification of the identification mark and inspecting a defect of a region where the identification mark is formed using the identification mark image; and
inspecting a defect of the circuit pattern using the circuit pattern image.

7. The method of claim 6, wherein performing identification of the identification mark and inspecting the defect of the region where the identification mark comprises:
obtaining the identification mark image;
identifying the identification mark using the identification mark image; and
inspecting the region where the identification mark is formed using the identification mark image after the identification mark is identified.

8. The method of claim 6, wherein the wafer image and the identification mark image have substantially a same magnification.

9. The method of claim 6, wherein inspecting the defect of the circuit pattern comprises:
obtaining the circuit pattern image;
comparing the circuit pattern image with at least one predetermined reference circuit pattern image by calculating gray level differences between a region of the circuit pattern image and a region of the at least one reference circuit pattern image; and
when any of the gray level differences are higher than a reference value, determining whether the circuit pattern has a defect.

10. An apparatus for inspecting a semiconductor wafer, comprising:
a wafer-aligning unit configured to align the semiconductor wafer;
an image-obtaining unit configured to obtain images of an identification mark and a circuit pattern on the semiconductor wafer;
a first image-processing unit configured to identify the identification mark using the identification mark image;
a second image-processing unit configured to inspect a defect of a region where the identification mark is formed using the identification mark image; and
a third image-processing unit configured to inspect a defect of the circuit pattern using the circuit pattern image.

11. The apparatus of claim 10, wherein the first image-processing unit is configured to determine whether the identification mark image matches any images of predetermined reference identification marks by comparing the identification mark image with at least one of the reference identification mark images.

12. The apparatus of claim 10, wherein the second image-processing unit comprises:
a first comparator configured to compare the identification mark image with at least one predetermined reference identification mark image and to calculate differences between gray levels of a region of the identification mark image and a region of the at least one reference identification mark image; and
a first determiner configured to compare the gray level differences with a reference value to determine whether the identification mark has a defect.

13. The apparatus of claim 10, wherein the third image-processing unit comprises:
a second comparator configured to compare the circuit pattern mark image with at least one predetermined reference circuit pattern image to calculate differences between gray levels of a region of the circuit pattern image and a region of the at least one reference circuit pattern image; and
a second determiner configured to compare the gray level differences with a reference value to determine whether the circuit pattern has a defect.
